(19) United States
(12) Patent Application Publication
(10) Pub. No.: US 2015/0278090 A1
(43) Pub. Date: Oct. 1, 2015

(54) Cache Driver Management of Hot Data

(71) Applicant: International Business Machines Corporation, Armonk, NY (US)

(72) Inventors: Xiaolei Hu, Shanghai (CN); Mengze Liao, Shanghai (CN); Yanlin Ren, Shanghai (CN); Yangming Wang, Shanghai (CN); Jinru Yan, Shanghai (CN); Jiang Yu, Shanghai (CN)

(21) Appl. No.: 14/656,878

(22) Filed: Mar. 13, 2015

Related U.S. Application Data
(63) Continuation of application No. 14/656,825, filed on Mar. 13, 2015.

(30) Foreign Application Priority Data
Mar. 26, 2014 (CN) 201410117237.8

(51) Int. Cl. G06F 12/08

(52) U.S. Cl. CPC G06F 12/0802; G06F 2212/1016; G06F 2212/60

(57) ABSTRACT

A cache driver, a host bus adapter and methods used by them are provided. The method used by the cache driver includes: receiving a first I/O request for accessing data, and sending a second I/O request to a host bus adapter (HBA). The cache driver sends the second I/O request in response to determining that the first I/O request accesses hot data on a HDD. In that case, the second I/O request is a request to the HBA to send a third I/O request to both the HDD and an SSD. The method used by the HBA includes: receiving a second I/O request from a cache driver. The second I/O request is a request to the HBA to send a third I/O request to both a HDD and an SSD. The HBA then sends the third I/O request.

### TECHNICAL FIELDS

The present invention relates to data storage, and more specifically, to a cache driver, a host bus adapter and methods used by them.

### BACKGROUND

Solid-state drive (SSD), due to its high performance, has been widely used as the cache of standard hard disk drives (HDD). The host cache software dynamically manages the SSD in conjunction with standard HDDs to provide users with SSD-level performance across the capacity of the HDDs.

Currently, the host cache software is implemented as a driver in the operating system (OS), referred to as a cache driver. In many input/output (I/O) operations such as reading and writing data that a business enterprise accesses frequently, i.e., “hot data,” I/O operations for both an HDD and an SSD are performed. During the I/O operations, the cache driver captures the I/O data being sent to the HDD by the host OS. The cache driver sends the data to the HDD (the first I/O operation) and calculates the data accessing frequency, i.e., the “temperature,” of the data. If the data accessing frequency is high, i.e., the data is hot, and is sent to a SSD cache, then the cache driver copies the data and transmits it to the SSD (the second I/O operation). Thus, double I/O operations are performed by the host cache software since I/O operations are executed for both the HDD and the SSD. Also, when the host cache software accesses the HDD and the SSD, data buffers used by the cache driver are located in different memory addresses, occupying a relatively large memory space.

The cache driver accesses the HDD and the SSD via a host bus adapter (HBA). The HBA may be a printed circuit board (PCB) and/or an integrated circuit adapter designed to provide both input and output processing and a physical connection between a server and a storage system. The peripheral component interconnect (PCI) bus, which is a frequently used I/O channel inside a server, uses a PCI protocol for communication between the server and peripheral units. Storage system I/O channels include fiber channel (FC), i.e., optical fiber, serial attached small computer system interface (SAS) and serial advanced technology attachment (SATA). One of the functions of the HBA is implementing protocol conversions between the PCI I/O channel and FC, SAS or SATA. The HBA may include a small processor, some memory for use as a data buffer, and connectors for connecting I/O devices, such as those implementing the SAS and SATA protocols. The protocol conversions, such as between PCI and SAS or SATA, among other functions, are performed in the small processor. As a result, the HBA reduces the burden of the main processor when performing the tasks associated with data storage and retrieval, and also increases the performance of the server.

I/O operations that are performed between the cache driver and the HBA during I/O that accesses the HDD and the SSD potentially impact server performance. Also, multiple data buffers are allocated in memory to perform the I/O accesses between the HBA and the HDD and the SSD, potentially increasing the amount of memory consumed while performing the I/O operations.

### SUMMARY

According to one embodiment of the present disclosure, a method used by a cache driver is provided. The method includes receiving a first I/O request to access data. The method also includes sending a second I/O request to a host bus adapter (HBA) in response to the data accessed by the first I/O request being hot data and the first I/O request accesses an HDD. The second I/O request is a request to the HBA to send a third I/O request to both the HDD and a SSD.

According to another embodiment of the present disclosure, a method used by a HBA is provided. The method includes: receiving a second I/O request from a cache driver, whereby the second I/O request is a request to the HBA to send a third I/O request to both an HDD and a SSD. The HBA sends third I/O request.

According to another embodiment of the present disclosure, a cache driver is provided. The cache driver includes a first receiving module, configured to receive a first I/O request to access data. The cache driver includes a sending module, configured to send a second I/O request to a host bus adapter (HBA) in response the data accessed by the first I/O request being hot data and the first I/O request accesses an HDD. The cache driver also provides a second I/O request whereby the second I/O request is a request to the HBA to send a third I/O request to both the HDD and a SSD.

According to yet another embodiment of the present disclosure, an HBA is provided. The HBA includes a receiving module, configured to receive a second I/O request from a cache driver, whereby the second I/O request is a request to the HBA to send a third I/O request to both an HDD and a SSD. The HBA also includes a sending module, configured to send the third I/O request.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 shows an exemplary computer system which is applicable to implement the embodiments of the present invention.

FIG. 2 is a process flow diagram related to an I/O operation of the condition of read-miss for hot data in existing technology.

FIG. 3 is a flowchart of a method used by a cache driver according to one embodiment of the invention.

FIG. 4 illustratively depicts a flowchart of a method used by an HBA.

FIG. 5 shows a process flow diagram related to an I/O operation of the condition of read-miss for hot data after using this invention.

FIG. 6 is a block diagram of a cache driver according to one embodiment of the invention.

FIG. 7 is a block diagram of an HBA according to one embodiment of the invention.

### DETAILED DESCRIPTION

Although an illustrative implementation of one or more embodiments is provided below, the disclosed systems and/or methods may be implemented using any number of techniques. The present disclosure can be implemented in various manners, and thus should not be construed to be limited to the embodiments disclosed herein.

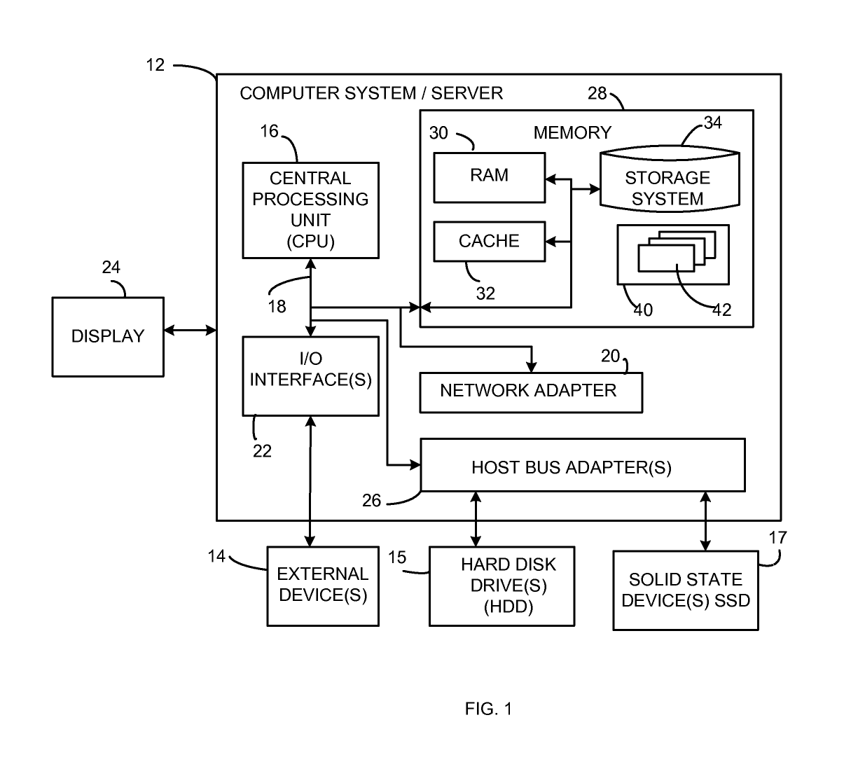

Referring now to FIG. 1, an exemplary computer system/server 12 is shown which is applicable to implement embodiments of the present invention. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set of program modules that are configured to carry out the functions of embodiments of the invention.

Program/utility 40, having a set of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc. one or more devices that enable a user to interact with computer system/server 12 and/or any devices (e.g., network card, modem, etc.) that enable computer system/server 12 to communicate with one or more other computing devices. Such communication can occur via Input/Output (I/O) interfaces 22. Computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. Host bus adapter (HBA) 26 connects the computer system/server 12 with external storage subsystems, such as hard disk drive(s) (HDD) 15 and solid state device(s) SSD 17. The HBA communicates with the processing unit 16 and memory 28 over bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In general operation, the cache driver receives I/O operations from the OS and, after packaging them for the protocol of the intended device, sends them for execution at the destination device. After receiving a read or write data request from an application, the cache driver calculates the data accessing frequency, i.e., data temperature, according to a cache algorithm such as, for example, most recently used (MRU) and least recently used (LRU). Based on the calculated data temperature, the cache driver decides whether to cache the data or not. For caching the data, the cache driver copies the data from an HDD to a SSD using I/O dispatching according to the type of the request (i.e. whether it is a read request or a write request).

A cache driver may execute many I/O operations to both the HDD and the SSD while executing the read or write requests associated with hot data. More specifically, these operations include the processing for the conditions of read-miss, write-hit and write-miss.

Generally speaking, an application accesses data through a cache driver. The read-miss condition occurs when the data read by application is hot, and the data is not present in the SSD cache. The write-hit condition occurs when the data written by application is hot, and the data is already present in the SSD cache. The write-miss condition occurs when the data written by application is hot, and the data is not present in the SSD cache.

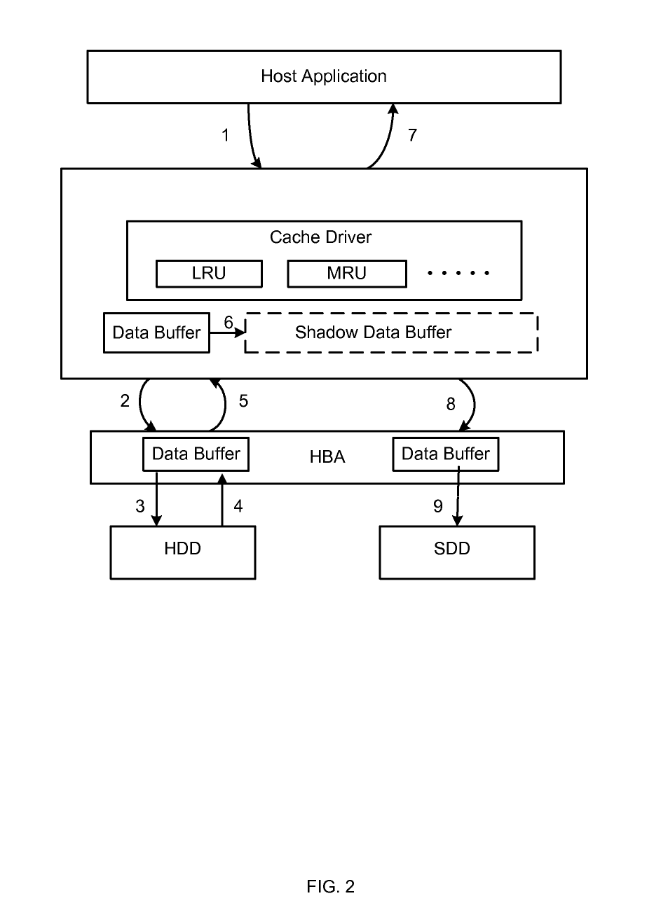

FIG. 2 is a process flow diagram, in current technology, illustrating a read-miss condition in an I/O operation for hot data. In Step 1, an application issues a read data request to a cache driver. In Step 2, the cache driver receives the read data request. The cache driver calculates the data temperature and determines that a read-miss occurred, since the data is hot but not present in a SSD cache. Therefore, the cache driver forwards the read data request to an HBA to read the data from an HDD. This is the first I/O operation of the cache driver. Simultaneously, the OS allocates a memory (i.e. data buffer) for the cache driver to store the read data. In Step 3, the HBA receives the request and sends command to the HDD to read the data. In Step 4, the HDD returns the read data to the HBA. In Step 5, the HBA returns the data to the cache driver and stores the read data into the data buffer. In Step 6, the OS allocates additional memory (i.e. shadow data buffer), into which the cache driver copies the read data. In step 7, the cache driver returns the read data to the application. In Step 8, the cache driver issues a new write data request to the HBA to write the data in the shadow data buffer to the SSD cache. This is the second I/O operation of the cache driver. In Step 9, the HBA receives the write data request and sends a command to the SSD cache to write the data.

The process flow diagram related to an I/O operation of write-miss or write-hit for hot data in existing technology can be illustrated in FIG. 2. The process can be described as below.

In Step 1, an application issues a write data request to a cache driver. In Step 2, the cache driver receives the request. The OS allocates memory for the cache driver (i.e. data buffer) to store the write data. The cache driver calculates the data temperate and determines that the data is hot but not present in SSD cache, i.e. write-miss or that the data is hot and present in SSD cache, i.e. write-hit. Therefore, the cache driver forwards the request to HBA (The first I/O operation of the cache driver). For the write-hit, the cache driver also makes the data in SSD data buffer invalid. In step 3, after receiving the write data request, the HBA sends a command to the HDD to write data. In step 4, the HDD notifies the HBA of the completion of writing data operation. In Step 5, the HBA returns to the cache driver a response indicating that the data writing operation completed successfully. In Step 6, the OS allocates additional memory (i.e., shadow data buffer) to the cache driver. The cache driver copies the written data to the shadow data buffer. In step 7, the cache driver returns to the application a response indicating that the data writing operation completed successfully. In Step 8, the cache driver issues a new write data request to the HBA to write the data in the shadow data buffer to the SSD cache. This is the second I/O operation of the cache driver. In Step 9, after receiving the new write data request, the HBA sends a command to the SSD cache to write the data from the shadow data buffer. The cache driver issues a new write data request writing the data in the shadow data buffer to the SSD cache.

It should be noted from the above process that the cache driver performs two I/O operations to satisfy the read and write requests for hot data to both the HDD and the SSD. Additionally, each of the two I/O operations requests the allocation of its own data buffer. The multiple I/O operations per I/O request, in combination with the buffer allocation requests, may contribute to a negative impact on computing resources and performance.

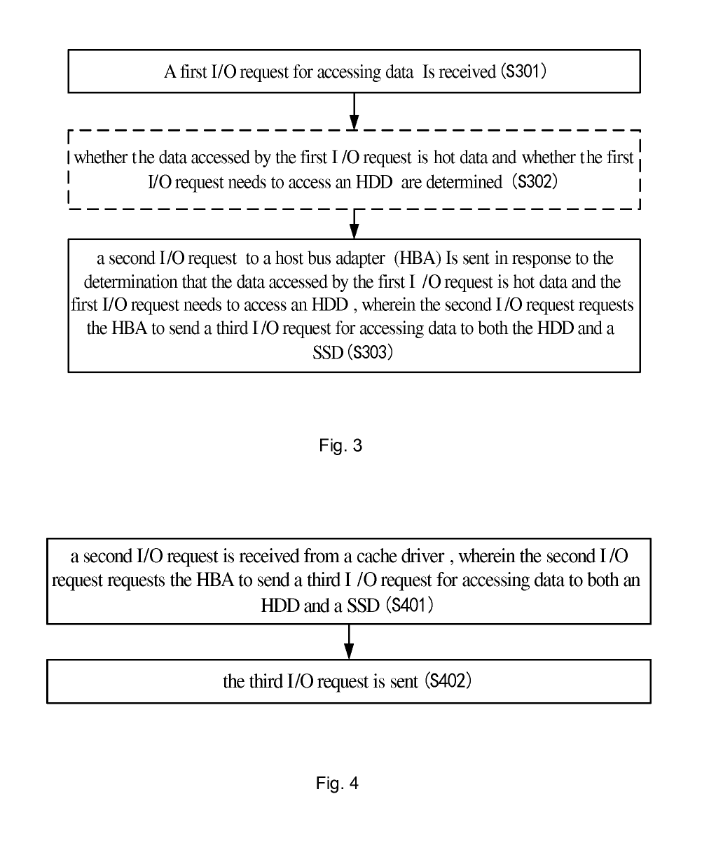

FIG. 3 is a flowchart of a method used by a cache driver according to one embodiment of the present disclosure. In Step S301, a first I/O request for accessing data is received at the cache driver. The first I/O request may be for either reading data or writing data. In Step S303, the cache driver sends a second I/O request to a host bus adapter (HBA). This second I/O request is in response to the cache driver determining that the data accessed by the first I/O request is hot data, and that the first I/O request accesses a standard HDD. The second I/O request includes a request for the HBA to send a third I/O request for accessing data to both the HDD and a SSD. In this embodiment, the cache driver generates the third I/O request to both the HDD and the SSD with only one I/O request (i.e., the second I/O request). In one embodiment, Step S303 is implemented as a command sent to the HBA by the cache driver, such as for example, a command of hot data read miss, hot data write hit or hot data write miss.

According to one embodiment, in Step S302, the cache driver determines whether the data of the first I/O request is hot data. The cache driver also determines whether the first I/O request accesses data on the standard HDD. When the cache driver determines that the first I/O request accesses hot data, performing the I/O request includes storing the data in the SSD. Additionally, when the cache driver determines that the first I/O request includes sending a request for accessing data to the HDD, the first I/O request includes accessing both the HDD and the SSD.

According to one embodiment, the first I/O request is a read data request. The third I/O request is a request to read data from the HDD, and write the read data from the HDD to the SSD. When the first I/O request is a read data request, but the requested data is not in the SSD, the cache driver recognizes a read-miss condition. A read-miss condition includes I/O operations to both the HDD and the SSD, since the data is accessed from the HDD and written to the SSD.

According to one embodiment, the first I/O request is a write data request. Performing the third I/O request includes writing the requested data to both the HDD and the SSD. When the first I/O request is a write data request, the cache driver may recognize a write-hit condition or a write-miss condition. The write-hit condition occurs when the data written by application is hot, and the data is already present in the SSD cache. The write-miss condition occurs when the data written by application is hot, but the data is not present in the SSD cache. Therefore, the data is written to the HDD, and may be written to the SSD depending on whether the cache driver recognizes a write-hit or write-miss condition.

The data accessed in either a read data request or a write data request is stored in a data buffer. In the various embodiments of this disclosure, the OS allocated the data buffer for the cache driver in response to receiving the first I/O request. One skilled in the art may well understand that in this disclosure, the second I/O request I/O operation to the SSD may be avoided. Additionally, memory resource is conserved, since the shadow data buffer may be eliminated.

The present disclosure also provides a method used by an HBA, as described in FIG. 4. In Step S401, a second I/O request is received from a cache driver, the first I/O request being that from the host application to the cache driver. The second I/O request is a request from the cache driver to the HBA to send a third I/O request for accessing data to both a standard HDD and a SSD. In Step S402, the third I/O request is sent. One skilled in the art may well appreciate that the HBA receives only one second I/O request from the cache driver. Based on the second I/O request, the HBA is able to send a third I/O request for accessing data to both the HDD and the SSD.

Similar to the embodiment presented in the method used by the cache driver, in the embodiment of FIG. 4, the second I/O request is a request to read data from the HDD and write the read data from the HDD to the SSD. Thus, Step S402 includes sending a read data request to the HDD, receiving the read data from the HDD, and writing the data read from the HDD into the SSD.

Similar to the embodiment presented in the method used by the cache driver, in the embodiment of FIG. 4, the third I/O request is a request to write data to both the HDD and the SSD. Thus, Step S402 includes sending the request to write data to both the HDD and the SSD. The cache driver may recognize a write-hit condition when the data to be written is present in the SSD. In this case, overwriting the data may be used. The cache driver may recognize a write-miss condition when the data to be written is not been present in the SSD. In this case, the data may be written into the SSD directly.

According to one embodiment, the data related to the second I/O request is stored in a data buffer of the HBA. The HBA only uses one I/O operation for storing the data related to the I/O operation. In contrast, one skilled in the art may recognize that in current technology, two data buffers are used to store the two duplicative contents (i.e., from the data buffer and the shadow data buffer), thus conserving memory and storage resources.

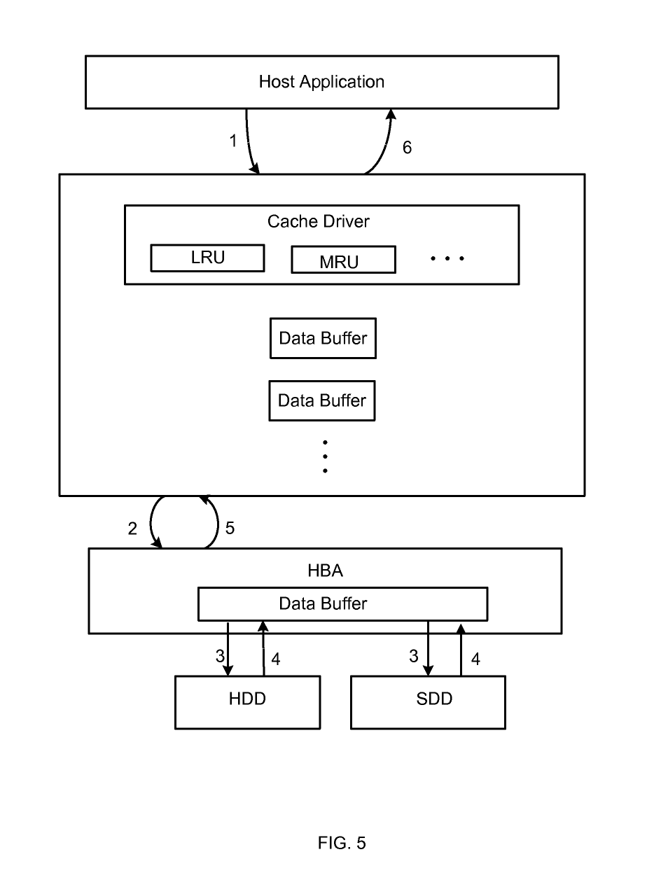

FIG. 5 is a process flow chart where the cache driver recognizes a read-miss condition in an I/O operation for hot data, according to various embodiments of the present disclosure. In Step 1, an application issues an I/O request to a cache driver. The I/O request may be for either reading data or writing data. In Step 2, the cache driver receives the I/O request. The cache driver calculates the temperature of the data, i.e., the frequency of the data access, and determines that the data is hot, i.e., frequently accessed. Based on the determination that the data being accessed is hot, the cache driver also determines that a read-miss, write-hit, or write-miss occurred, depending on whether the data is present in the SSD. The cache driver sends a second I/O request to an HBA which requests the HBA to send a third I/O request to both an HDD and a SSD. In Step 3, the HBA issues the third I/O operation to both the HDD and the SSD to read or write data. For example, if the first I/O request is to read data, then the second I/O request is a request to the HDD for reading data for writing the data read from the HDD to the SSD. If the first I/O request is to write data, then the second I/O request is a request for writing data to both the HDD and the SSD. In Step 4, the HBA gets the results of the execution of the second I/O request from the HDD and the SSD. Specifically, if the first I/O request is to read data, the result of the second I/O request is the read data. If the first I/O request is to write data, the result of the second I/O request is a tag that means the write data request has been successfully executed. In Step 5, the HBA returns the result of the second I/O request to the cache driver, which caches the data. In Step 6, the cache driver returns the results to the application.

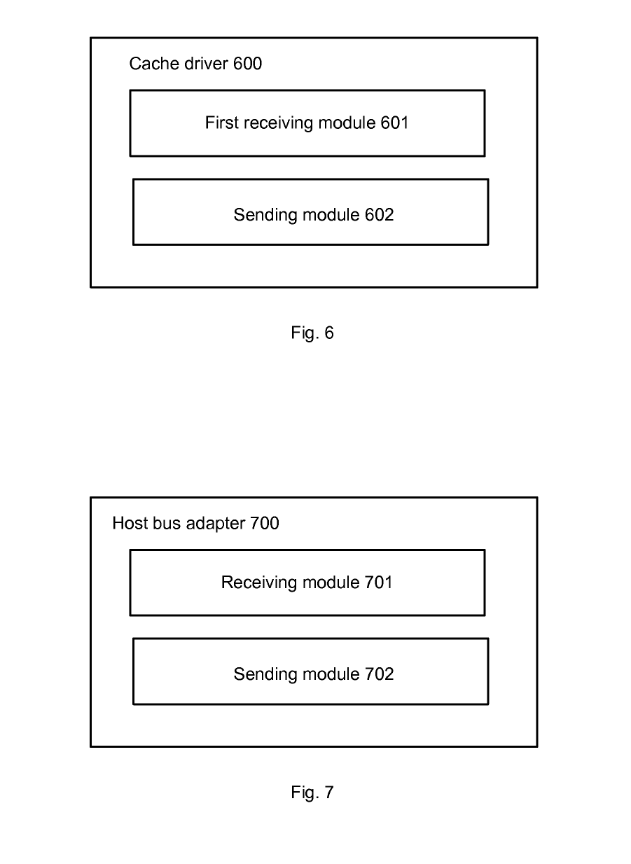

FIG. 6 is a block diagram of a cache driver 600 according to one embodiment of the present disclosure. According to FIG. 6, the cache driver 600 includes a first receiving module 601 configured to receive a first I/O request for accessing data, and a sending module 602, configured to send a second I/O request to an HBA. The second I/O request is in response to the cache driver determining that the data accessed by the first I/O request is hot data, and that the first I/O request accesses a standard HDD. In this embodiment, the second I/O request includes a request to the HBA to send a third I/O request for accessing data to both the HDD and a SSD.

According to an embodiment of the disclosure, the first I/O request is a read data request, and the third I/O request is a request to read data from the HDD and to write the data read from the HDD to the SSD. Thus, the cache driver 600 further comprises (not shown in FIG. 6) a second receiving module, configured to receive from the HBA the data read from the HDD.

According to an embodiment of the invention, the first I/O request is a write data request, and the third I/O request is a request to write data to both the HDD and the SSD.

According to an embodiment of the invention, the data related to the first I/O request is stored in a data buffer. The OS allocates the data buffer for the cache driver in response to the cache driver receiving the first I/O request.

FIG. 7 is a block diagram of an HBA 700 according to one embodiment of the present disclosure. According to one embodiment of the invention, the HBA 700 includes a receiving module 701, configured to receive a second I/O request from a cache driver. The second I/O request is a request to the HBA to send a third I/O request to both a standard HDD and a SSD. This embodiment also includes a sending module 702, configured to send the third I/O request.

According to an embodiment of the disclosure, the third I/O request is a request to read data from the HDD and to write the read data from the HDD to the SSD. Thus, the sending module 702 further comprises (not shown in FIG. 7) a read data request sending module, configured to send a read data request to the HDD, a data receiving module, configured to receive the read data from the HDD, and a write data request sending means, configured to send a write data request to write the read data into the SSD.

According to an embodiment of the invention, the second I/O request is related to a write data request, and the third I/O request is a request to write data related to the write data request to both the HDD and the SSD.

According to an embodiment of the invention, the data related to the second I/O request is stored in a data buffer of the HBA.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method used by a host bus adapter (HBA), comprising:
receiving a second I/O request from a cache driver, wherein the second I/O request is a request to the HBA to send a third I/O request to both a HDD and an SSD; and
sending the third I/O request.

2. The method according to claim 1, wherein the third I/O request is a request to read data from the HDD and to write the read data from the HDD to the SSD.

3. The method according to claim 2, wherein sending the third I/O request comprises:
sending a read data request to the HDD;
receiving the read data from the HDD; and
writing the read data received from the HDD into the SSD.

4. The method according to claim 1, wherein the third I/O request is a write data request, and the third I/O request is a request to write data related to the write data request to both the HDD and the SSD.

5. The method according to claim 1, wherein data related to the second I/O request is stored in one data buffer of the HBA, and the storing is performed in one I/O operation.

6. A host bus adapter (HBA), comprising:
a receiving module, configured to receive a second I/O request from a cache driver, wherein the second I/O request is a request to the HBA to send a third I/O request to both a HDD and an SSD; and
a sending module, configured to send the third I/O request.

7. The HBA according to claim 6, wherein the third I/O request is a request to read data from the HDD and to write the read data from the HDD to the SSD.

8. The HBA according to claim 6, wherein the sending module comprises:
a read data request sending module, configured to send a read data request to the HDD;
a data receiving means, configured to receive the read data from the HDD; and
a write data request sending module, configured to write the read data received into the SSD.

9. The HBA according to claim 6, wherein the second I/O request is a write data request, and the third I/O request is a request to write data related to the write data request to both the HDD and the SSD.

10. The HBA according to claim 6, wherein the data related to the second I/O request is stored in a data buffer of the HBA.
